(19) United States
(12) Patent Application Publication
(10) Pub. No.: US 2015/0271114 A1
(43) Pub. Date: Sep. 24, 2015

(54) SYSTEM AND METHOD FOR COMMUNICATION BETWEEN COMPUTING DEVICES

(71) Applicant: StorySafe Digital, LLC, Indianapolis, IN (US)

(72) Inventor: Attila Schillinger, Budapest (HU)

(21) Appl. No.: 14/662,871

(22) Filed: Mar. 19, 2015

Related U.S. Application Data
(60) Provisional application No. 61/955,670, filed on Mar. 19, 2014.

(51) Int. Cl. H04L 12/58; G06F 3/0484; G06F 3/0482; H04L 29/06; H04L 12/24

(52) U.S. Cl. CPC H04L 51/046; H04L 65/403; H04L 41/22; G06F 3/0482; G06F 3/04842

(57) ABSTRACT

A first computing device receives a user input to request content from a second computing device. The first computing device transmits a request for content to the second computing device. The second computing device receives the request for content. The second computing device receives a user selection of content to transmit to the first computing device in response to the request for content. The second computing device transmits the user-selected content to the first computing device. Tire first computing device receives the user-selected content. The user-selected content is displayed on a graphical user interlace (GUI) of the first computing device.

### CROSS REFERENCE TO RELATED APPLICATIONS

The present application claims the benefit of U.S. Provisional Patent Application No. 61/955,670 filed Mar. 19, 2014, which is incorporated herein by reference in its entirety.

### BACKGROUND

The present invention generally relates to communication between computing devices. In the current system of personal broadcasting, people may receive more than a thousand pieces of content a day, but the content may not be the content that they want or seek. Some existing systems have various shortcomings relative to certain applications. Accordingly, there remains an interest for further contributions in this area of communications technology.

### SUMMARY

One embodiment of the present invention is a unique system and method for communication between devices. Other embodiments include apparatuses, systems, devices, hardware, methods, and combinations for communication between devices. Further embodiments, forms, features, aspects, benefits, and advantages of the present application shall become apparent from the description and figures provided herewith.

### BRIEF DESCRIPTION OF THE FIGURES

The description herein makes reference to the accompanying figures wherein like reference numerals refer to like parts throughout the several views, and wherein:

FIG. 1 is a schematic diagram of an exemplary system.

FIG. 2 is a schematic diagram of an exemplary computing device.

FIG. 3 is an exemplary illustration of a menu graphical user interface (GUI).

FIG. 4 is an exemplary illustration of an invite GUI.

FIG. 5 is an exemplary illustration of a send request GUI.

FIG. 6 is an exemplary illustration of a send request GUI after a request is sent.

FIG. 7 is an exemplary illustration of a request list GUI.

FIG. 8 is an exemplary illustration of an add content GUI.

FIG. 9 is an exemplary illustration of a home page GUI.

FIG. 10 is a schematic flow diagram of an exemplary process for communicating between computing devices.

### DETAILED DESCRIPTION OF EXEMPLARY EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is hereby intended. Any alterations and further modifications in the described embodiments, and any further applications of the principles of the invention as described herein are contemplated as would normally occur to one skilled in the art to which the invention relates.

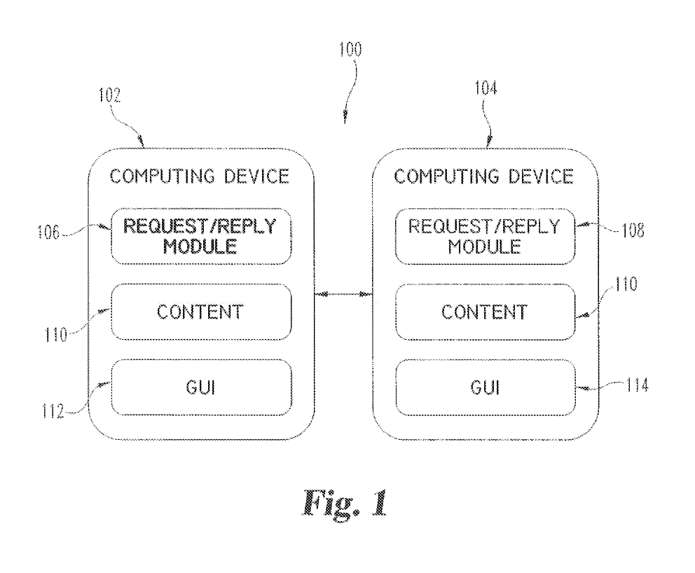

The present application provides a communications technology tool that allows people to receive the content they want and/or get an acquaintance or partner to create the content requested if it does not exist (e.g., take a photo and send it, provide an update/text message, etc.). FIG. 1 illustrates an exemplary system 100 including a first computing device 102 and a second computing device 104, which may be any type of computing device such as a smartphone, tablet computer, laptop computer, desktop computer, a server, a smart watch, and the like. It is contemplated that at least one of the computing devices in some embodiments may be wearable, or be part of another object such as a vehicle. It is contemplated that more than two computing devices may communicate with one another in other embodiments. The first computing device 102 includes a request/reply module 106 and the second computing device 104 includes a request/reply module 108 to communicate with one another. It is contemplated that the functionality of the request/reply module 106 and the request/reply module 108 may be provided by one or more modules in other embodiments and/or implementations.

The first computing device 102 and the second computing device 104 may communicate with one another using a wired or wireless connection. Furthermore, the first computing device 102 and the second computing device 104 may communicate with one another via any suitable network such as the Internet and/or cellular data network. The first computing device 102 and the second computing device 104 may be configured to provide appropriate signal conditioning to transmit and receive desired information (data), and correspondingly may include filters, amplifiers, limiters, modulators, demodulators, CODECs, digital signal processing, and/or different circuitry or functional components as would occur to those skilled in the art to perform the desired communications.

The request/reply module 106 of the first computing device 102 is structured to receive a user input to request content from the second computing device 104. The request/reply module 106 of the first computing device 102 is further structured to transmit a request for content to the second computing device 104.

The request/reply module 108 of the second computing device 104 is structured to receive the request for content and to receive a user selection of content 110 to transmit to the first computing device 102 in response to the request for content. Then, the request/reply module 108 of the second computing device 104 is structured to transmit the user-selected content to the first computing device 102.

The request/reply module 106 of the first computing device 102 is structured to receive the user-selected content at the first computing device 102. The request/reply module 106 of the first computing device 102 is further structured to display the user-selected content 110 on a graphical user interface (GUI) 112 on a display device (e.g., a liquid crystal display) of the first computing device 102.

The request/reply module 108 of the second computing device 104 may be structured to display a list of pending received requests for content on a GUI 114 on display device (e.g., a liquid crystal display) of the second computing device 104. The request/reply module 106 of the first computing device 102 may be structured to display a list of pending sent requests for content on the GUI 112 of the first computing device 102.

The request/reply module 108 of the second computing device 104 may be structured to display a badge or icon indicative of a number of pending requests for content received at the second computing device 104.

The content 110 may be a text message, a photo, a video, and/or any other content to be shared between two computing devices. The photo may be a user-selectable photo stored in a library or memory on the second computing device 104. The text message may be a pre-defined, user-selectable message that a user may select from a list of messages stored in a library or memory on the second computing device 104. The video may be a user-selectable video stored in a library or memory on the second computing device 104. In some embodiments, the text message, the photo, and/or the video are created in real-time with the second computing device 104. For example, the user may type text message into the second computing device 104, and/or take a picture or video with a camera on the second computing device 104. The user may add a caption or text message to a photo or video before it is sent to the first computing device.

The request/reply module 106 and/or the request/reply module 108 may be structured to display an invite GUI that allows a user to input identifying information, such as an email address, that is used to link the first computing device 102 and the second computing device 104 for communication via the modules 106, 108. It is contemplated that other types of information instead of or in addition to an email address may be used to link the devices 102, 104.

The request/reply module 106 of the first computing device 104 may be structured to display the user-selected content 110 in a timeline on the GUI 112. The request/reply module 108 of the second computing device 104 may be structured to display an add content GUI on the second computing device to receive the user selection of content 110 to transmit to the first computing device 102.

To preserve clarity, the description designates the first computing device 102 as the requesting device and the second computing device 104 as the replying device. However, it is contemplated that both devices have the same functionality via the request/reply module so that each device may send requests and replies in other embodiments and/or implementations.

It is contemplated that the first computing device 102 and the second computing device 104 communicate via a server (not shown). In some embodiments, new data is pushed and/or synced to the server. The server may also store content such as photos, text messages, and/or videos. The server may push notifications to the first computing device 102 and/or the second computing device 104. The server may also link two or more computing devices together for communication based on, for example, an email address(es).

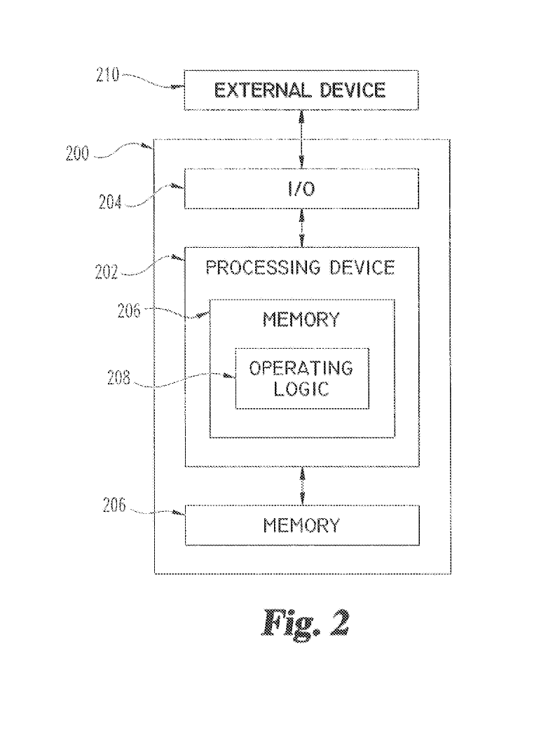

FIG. 2 is a schematic block diagram of a computing device 200. The computing device 200 is one example of a computing device configuration that may be utilized in connection with the first computing device 102 and the second computing device 104 shown in FIG. 1. Computing device 200 includes a processing device 202, an input/output device 204, memory 206, and operating logic 208. Furthermore, computing device 200 communicates with one or more external devices 210.

The input/output device 204 allows the computing device 200 to communicate with the external device 210. For example, the input/output device 204 may be a transceiver, network adapter, network card, interface, or a port (e.g., a USB port, serial port, parallel port, an analog port, a digital port, VGA, DVI, HDMI, FireWire, CAT 5, or any other type of port or interface). The input/output device 204 may be include hardware, software, and/or firmware. It is contemplated that the input/output device 204 will include more than one of these adapters, cards, or ports.

The external device 210 may be any type of device that allows data to be inputted or outputted from the computing device 200. For example, the external device 210 may be another computing device, camera, a mobile device, equipment, a handheld computer, a diagnostic tool, a controller, a computer, a server, a processing system, a printer, a display, an alarm, an illuminated indicator such as a status indicator, a keyboard, a mouse, or a touch screen display. Furthermore, it is contemplated that the external device 210 may be integrated into the computing device 200. It is further contemplated that there may be more than one external device in communication with the computing device 200.

Processing device 202 can be a programmable type, a dedicated, hardwired state machine, or any combination of these. The processing device 202 may further include multiple processors, Arithmetic-Logic Units (ALUs), Central Processing Units (CPUs), Digital Signal Processors (DSPs), or the like. Processing devices 202 with multiple processing units may utilize distributed, pipelined, and/or parallel processing. Processing device 202 may be dedicated to performance of just the operations described herein or may be utilized in one or more additional applications. In the depicted form, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 may include one or more components of any type suitable to process the signals received from input/output device 204 or elsewhere, and to provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a combination of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. As shown in FIG. 2, memory 206 may be included with processing device 202 and/or coupled to the processing device 202.

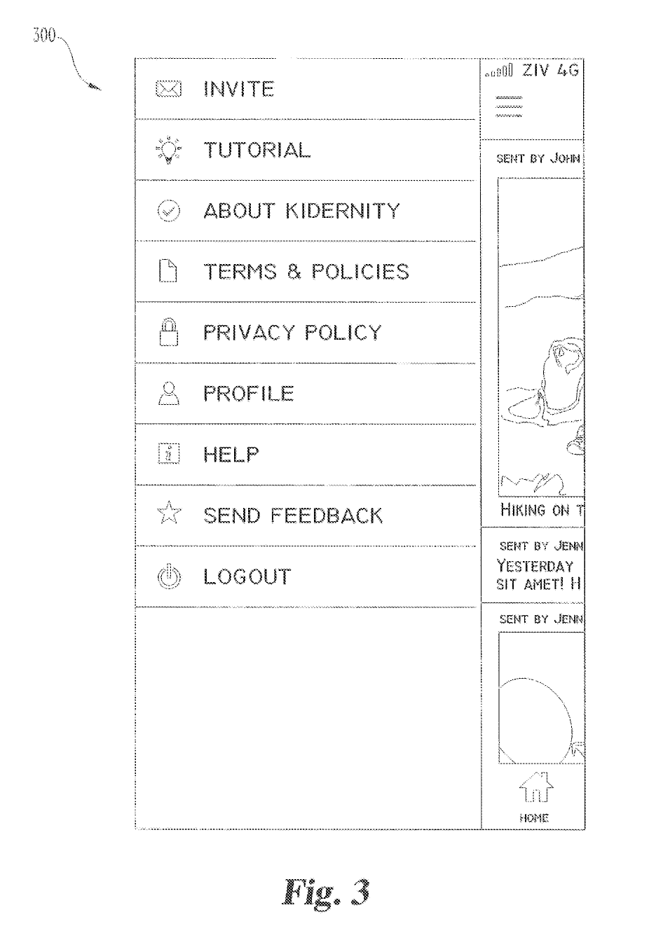

The various GUIs illustrated in FIGS. 3-9 may be implemented by the request/reply module 106, 108 and GUIs 112, 114, and displayed by a display device on the devices 102, 104. Although some embodiments in FIGS. 3-9 may only show a text message and/or a photo, other types of content, such as videos, may be used in the various embodiments shown in FIGS. 3-9. Furthermore, although some embodiments in FIGS. 3-9 may show tapping as the user input, any other type of user input may be used such as voice commands.

FIG. 3 is an exemplary illustration of a menu GUI 300. The menu GUI 300 may include links to several different menu items such as invite, tutorial, about, terms and policies, privacy policy, profile, help, feedback, and/or logout.

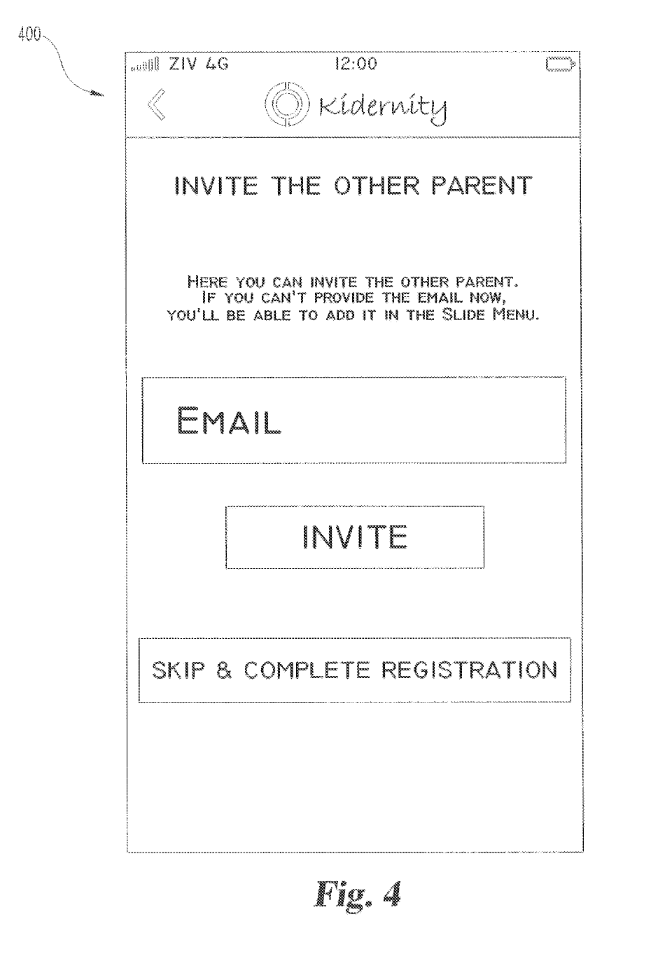

FIG. 4 is an exemplary illustration of an invite GUI 400. In one embodiment, the invite GUI 400 receives the email address of the invitee. The invitee may then receive an email invite and downloads the request/reply module by tapping on the link that was sent in the email. The invitee may then complete a sign-up and then the request/reply module 106, 108 may automatically link the two computing devices 102, 104. A user can invite another person by tapping on the “Invite” line of the slide-in menu GUI 300.

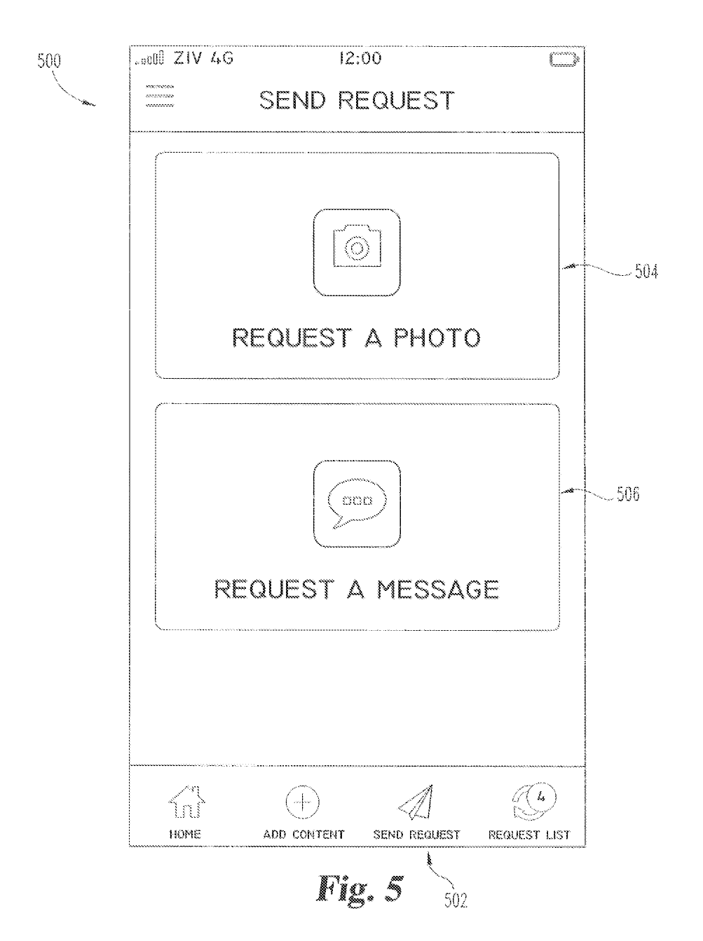

FIG. 5 is an exemplary illustration of a send request GUI 500. To send a request, a user may tap the “Send Request” button 502 on the tab bar to access the send request GUI 500 of the request/reply module 106, 108. The send request GUI 500 illustrated in FIG. 5 provides two options to users: “Request a Photo” button 504 or “Request a Text Message” button 506. The two buttons can be tapped separately on the screen. By tapping on one of the buttons, the request/reply module 106 sends either a photo or a text message request to the computing device of the other user. It is contemplated that another button for requesting a video or other content may be used.

In one embodiment, a user may send multiple requests, although once a photo, text message, or video is requested, further similar requests will serve as ‘reminders’ and may be displayed on the request lists of both the sender and the receiver. It is contemplated that the similar requests may be grouped together and include a badge or icon with a number indicating how many similar requests have been sent.

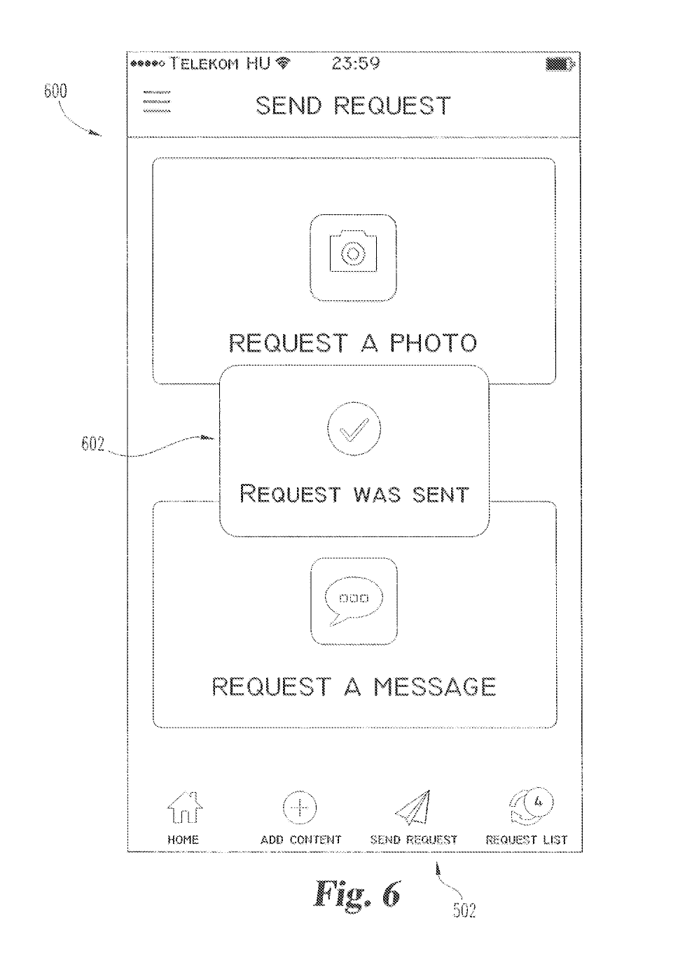

FIG. 6 is an exemplary illustration of a send request GUI 600 after a request is sent. In one embodiment, once the request for content is sent, the “Request Sent” popup 602 appears in the middle of the send request GUI 600.

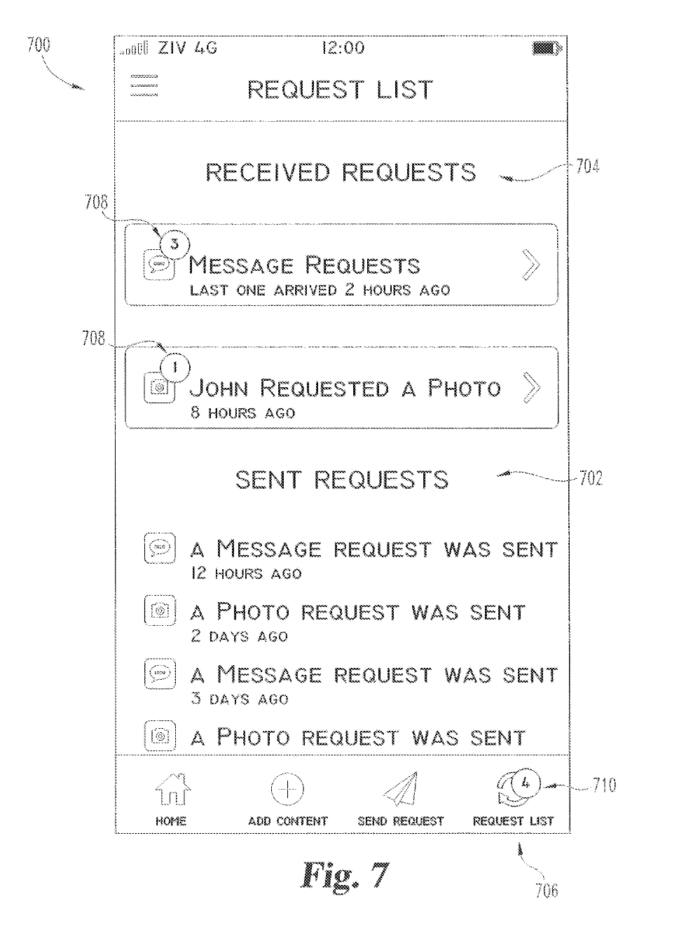

FIG. 7 is an exemplary illustration of a request list GUI 700. As seen in FIG. 7, sent and received requests are listed separately under “Sent Requests” 702 and “Received Request” 704 in the request list GUI 700. A user can access his or her lists by tapping on the “Request List” button 706 on the tab bar. In some embodiments, similar received requests are grouped toward the top of the request list GUI 700, while sent requests are listed individually below. Furthermore, grouped received requests may display the number of similar requests (photo or text message) received on the badge or icon 708 of the received request displayed on the request list screen.

In some embodiments, when a user receives a new request (text message or photo) a new notification may be displayed in a notification center on the computing device and a badge with a number of current new requests/text messages/photos that appears on the request/reply module icon. A similar badge or icon 710 may appear on the “Request List” button 706 on the tab bar. The push notification may change with the number of requests received. The notification typically disappears when the user views the received requests. The notification “seen” may appear on the sender's “Sent Request” list on the items viewed by the receiver.

Sent Request items may disappear from the user's Request List when the recipient responds to the request by adding the requested new photo or text message to the timeline. Received Request items may disappear from the user's Request List when the user responds to the request received by adding the new photo or text message to the timeline requested by the sender.

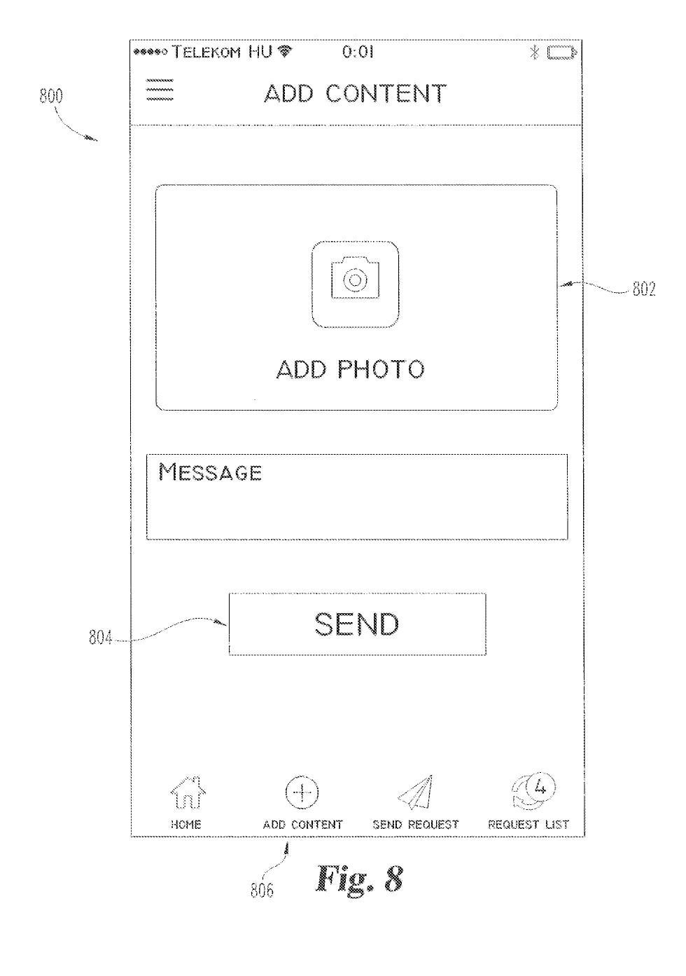

FIG. 8 is an exemplary illustration of an add content GUI 800. A user can reply to a request by tapping on a group of the same type of Received Requests items on the request list GUI 700. The add content GUI 800 will then appear. On the add content GUI 800 the user may select the type of content—photo or text message—they intend to send as a reply to the request received. Photos can be selected from the library of the computing device using the “Add Photo” button 802 and/or taken in real-time and sent with or without a caption (text message). Text messages are typed in the message box and can be sent with or without adding a photo. It is contemplated that a video may be added in other embodiments.

Both photo and text messages are sent by adding the content and tapping on the ‘Send’ button 804 at the bottom of the add content GUI 800. Once a text message is sent, the text message appears on the home page GUI 900. When a photo is being sent, a color line may run across the top of the screen signaling that the photo is being uploaded. When the line fully extends across the top of the screen, a “photo uploaded” popup may appear in the middle of the screen while the app switches to home page GUI 900 displaying the new photo.

When the user replies to a message request received and adds a photo, the reply constitutes a reply to any photo message request received by the same user. As a result, at the time of sending the reply, both the message request and photo request disappear from the Received Requests Request List of the user. This approach may also apply to replying to a photo request and adding a text message. At the time of sending the reply, both the photo request and message request disappear from the Received Requests Request List of the user. Replying to a photo or text message request is regarded as a reply to all similar requests received.

Users may choose to ignore Received Requests. In this case, any added content by the user will be regarded as a reply to any previous request as long as the content added is the same (either text message or photo) as requested by the other user. Text messages or photos can also be added regardless of receiving a request by tapping on the “Add Content” button 806 on the tab bar of the request/reply module 106, 108. Once content that matches the request is added by the user, the same type of content request disappears from the Sent Requests Request List of the sender and the Received Requests Request List of the receiver.

A user may add content without any request. If a requestor has received a request for the type of content the user is adding without hitting the received request (i.e., without the intention of responding directly to the request) the request received will disappear because the request/reply module 108 will assume that the user satisfied the requestor's request by sending the type of information requested even if unintended or not directly linked to that request.

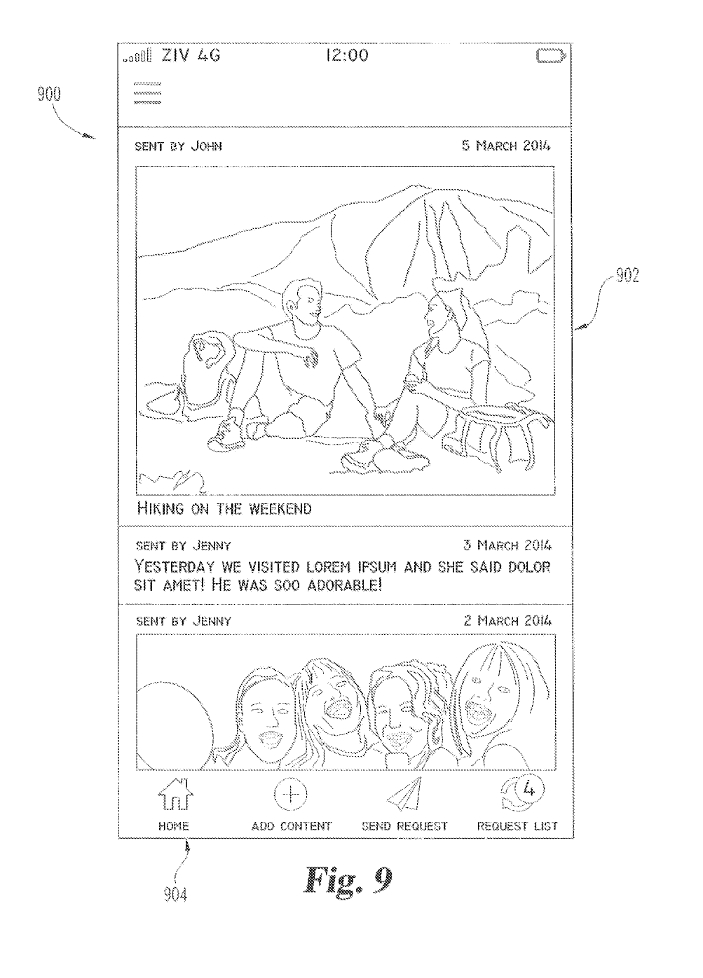

FIG. 9 is an exemplary illustration of a home page GUI 900, which includes a timeline 902 of the request/reply module 106, 108. The timeline 902 of the home page 900 will list messages and/or photos received from another computing device. If a photo has a caption, the caption will appear underneath the associated photo. A user may access the home page GUI 900 by tapping the “Home” button 904 on the tab bar.

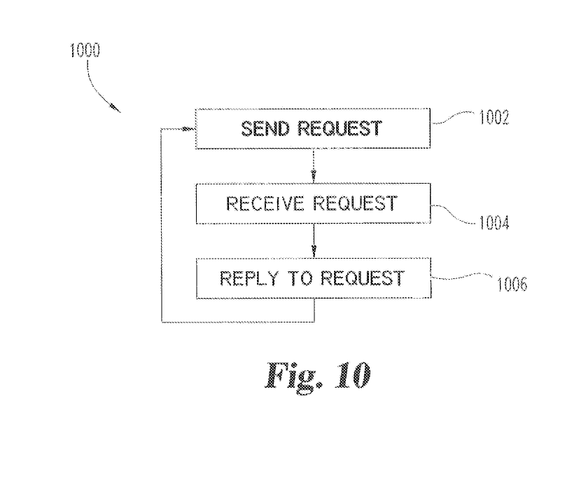

FIG. 10 is a schematic flow diagram of an exemplary process for communicating between computing devices. Operations illustrated for all of the processes in the present application are understood to be examples only, and operations may be combined or divided, and added or removed, as well as re-ordered in whole or in part, unless explicitly stated to the contrary.

Process 1000 begins at operation 1002 in which a first computing device 102 transmits a request for content to a second computing device 104 as described above. Process 1000 then proceeds from operation 1002 to operation 1004 in which the second computing device 104 receives the request for content as described above. Process 1000 then proceeds from operation 1004 to operation 1006 in which the second computing device 104 replies to the request for content by transmitting the requested content to the first computing device 102 as described above.

The various aspects of the process 1000 and the request/reply module 106 in the present application may be implemented in operating logic 208 as operations by software, hardware, and/or at least partially performed by a user or operator. In certain embodiments, operations represent software elements as a computer program encoded on a computer readable medium, wherein the processing device 202 of the first computing device 102 and/or the processing device 202 of the second computing device performs the described operations when executing the computer program.

One aspect of the present application includes a method, comprising: receiving, at a first computing device, a user input to request content from a second computing device; transmitting a request for content from the first computing device to the second computing device; receiving the request for content at the second computing device; receiving a user selection of content to transmit to the first computing device in response to the request for content; transmitting the user-selected content to the first computing device; receiving the user-selected content at the first computing device; and displaying the user-selected content on a graphical user interface (GUI) of the first computing device.

Features of the aspect may include: displaying a list of pending received requests for content on a GUI of the second computing device; displaying a list of pending sent requests for content on the first computing device; displaying a badge indicative of a number of pending requests for content; wherein the content is at least one of a text message, a photo, and a video; wherein the photo is a user-selectable photo stored in a library on the second computing device; wherein the text message is a pre-defined, user-selectable message stored in a library on the second computing device; wherein the video is a user-selectable video stored in a library on the second computing device; wherein at least one of the text message, the photo, and the video are created in real-time with the second computing device; adding a caption to at least one of the photo and video; wherein at least one of the first computing device and the second computing device is a smartphone; displaying an invite GUI to receive an email address to link the first computing device and the second computing device for communication; wherein displaying the user-selected content on the GUI of the first computing device further includes displaying the user-selected content in a timeline on the GUI of the first computing device; displaying an add content GUI on the second computing device to receive the user selection of content to transmit to the first computing device; transmitting, one of the first computing device and the second computing device, a second request for content to a third computing device.

Another aspect of the present application includes a system, comprising: a first computing device; and a second computing device, wherein the first computing device is structured to receive a user input to request content from the second computing device and to transmit a request for content to the second computing device, wherein the second computing device is structured to receive the request for content from the first computing device, to receive a user selection of content to transmit to the first computing device in response to the request for content, and to transmit the user-selected content to the first computing device, and wherein the first computing device is further structured to receive the user-selected content and display the user-selected content on a graphical user interface (GUI).

Features of the aspect may include: wherein at least one of the first computing device and the second computing device is a smartphone; wherein the first computing device and the second computing device each include a request/reply module; wherein the first computing device and the second computing device are linked by the request/reply modules via an email address.

Yet another aspect of the present application includes a method, comprising: receiving, at a first computing device with a request content graphical user interface (GUI) button, a user input to request content from a second computing device; transmitting a request for content from the first computing device to the second computing device; receiving the request for content at the second computing device; displaying an add content GUI on the second computing device to receive a user selection of content to transmit to the first computing device; receiving, via the add content GUI, the user selection of content to transmit to the first computing device in response to the request for content; transmitting the user-selected content to the first computing device; receiving the user-selected content at the first computing device; and displaying the user-selected content on a GUI of the first computing device.

Features of the aspect may include: displaying a list of pending received requests for content on a GUI of the second computing device; displaying a list of pending sent requests for content on the first computing device; displaying a badge indicative of a number of pending requests for content; wherein the content is at least one of a text message, a photo, and a video; wherein the photo is a user-selectable photo stored in a library on the second computing device; wherein the text message is a pre-defined, user-selectable message stored in a library on the second computing device; wherein the video is a user-selectable video stored in a library on the second computing device; wherein at least one of the text message, the photo, and the video are created in real-time with the second computing device; adding a caption to at least one of the photo and video; wherein at least one of the first computing device and the second computing device is a smartphone; displaying an invite GUI to receive an email address to link the first computing device and the second computing device for communication; wherein displaying the user-selected content on the GUI of the first computing device further includes displaying the user-selected content in a timeline on the GUI of the first computing device.

Another aspect of the present application includes a system, comprising: a first computing device; and a second computing device, wherein the first computing device is structured to receive a user input with a request content graphical user interface (GUI) button to request content from the second computing device and to transmit a request for content to the second computing device, wherein the second computing device is structured to receive the request for content from the first computing device, to receive a user selection of content with an add content GUI to transmit to the first computing device in response to the request for content, and to transmit the user-selected content to the first computing device, and wherein the first computing device is further structured to receive the user-selected content and display the user-selected content in a timeline on the GUI of the first computing device.

Features of the aspect of the present application may include: wherein at least one of the first computing device and the second computing device is a smartphone; wherein the first computing device and the second computing device each include a request/reply module; wherein the first computing device and the second computing device are linked by the request/reply modules via an email address.

Yet another aspect of the present application includes a method, comprising: displaying an invite GUI to receive an email address to link a first computing device and a second computing device for communication; receiving, at a first computing device with a request content graphical user interface (GUI) button, a user input to request content from a second computing device; transmitting a request for content from the first computing device to the second computing device; receiving the request for content at the second computing device; displaying a list of pending received requests for content on a GUI of the second computing device; displaying an add content GUI on the second computing device to receive a user selection of content to transmit to the first computing device; receiving, via the add content GUI, the user selection of content to transmit to the first computing device in response to the request for content; transmitting the user-selected content to the first computing device; receiving the user-selected content at the first computing device; and displaying the user-selected content on a GUI of the first computing device.

Features of the aspect of the present application may include: wherein at least one of the first computing device and the second computing device is a smartphone; wherein displaying the user-selected content on the GUI of the first computing device further includes displaying the user-selected content in a timeline on the GUI of the first computing device.

While the invention has been described in connection with what is presently considered to be the preferred embodiment, it is to be understood that the invention is not to be limited to the disclosed embodiment(s), but on the contrary, is intended to cover various modifications and equivalent arrangements. Furthermore it should be understood that while the use of the word “preferable,” “preferably,” or “preferred” in the description above indicates that feature so described may be more desirable, it nonetheless may not be necessary and any embodiment lacking the same may be contemplated as within the scope of the invention. Further, when the language “at least a portion” and/or “a portion” is used the item may include a portion and/or the entire item unless specifically stated to the contrary.

What is claimed is:

1. A method, comprising:
receiving, at a first computing device with a request content graphical user interface (GUI) button, a user input to request content from a second computing device:
transmitting a request for content from the first computing device to the second compiling device;
receiving the request for content at the second computing device;
displaying an add content GUI on the second computing device to receive a user selection of content to transmit to the first computing device;
receiving, via the add content GUI. the user selection of content to transmit to the first computing device in response to the request for content;
transmitting the user-selected content to the first computing device;
receiving the user-selected content at the first computing device; and
displaying the user-selected content on a GUI of the first computing device.

2. The method of claim 1, further comprising:
displaying a list of pending received requests for content on a GUI of the second computing device.

3. The method of claim I, further comprising:
displaying a list of pending sent requests for content on the first computing device.

4. The method of claim 1, further comprising:
displaying a badge indicative of a number of pending requests for content.

5. The method of claim 1, wherein the content is at least one of a text message, a photo, and a video.

6. The method of claim 5, wherein the photo is a user-selectable photo stored in a library on the second computing device.

7. The method of claim 5, wherein the text message is a pre-defined, user-selectable message stored in a library on the second computing device,

8. The method of claim 5, wherein the video is a user-selectable video stored in a library on the second computing device.

9. The method of claim 5, wherein at least one of the text message, the photo, and the video are created in real-time with the second computing device.

10. The method of claim 5, further comprising:
adding a caption to at least one of the photo and video.

11. The method of claim 1, wherein at least one of the first computing device and the second computing device is a smartphone.

12. The method of claim 1, further comprising:
displaying an invite GUI to receive an email address to link the first computing device and the second computing device for communication.

13. The method of claim 1, wherein displaying the user-selected content on the GUI of the first computing device further includes displaying the user-selected content in a timeline on the GUI of the first computing device.

14. A system, comprising:
a first computing device; and
a second computing device,
wherein the first computing device is structured to receive a user input with a request content graphical user interface (GUI) button to request content from the second computing device and to transmit a request tor content to the second computing device,
wherein the second computing device is structured to receive the request for content from the first computing device, to receive a user selection of content with an add content GUI to transmit to the first computing device in response to the request for content, and to transmit the user-selected content to the first computing device, and
wherein the first computing device is further structured to receive the user-selected content and display the user-selected content in a timeline on the GUI of the first computing device.

15. The system of claim 14, wherein at least one of the first computing device and the second computing device is a smartphone.

16. The system of claim 14, wherein the first computing device and the second computing device each include a request/reply module.

17. The system of claim 16, wherein the first computing device and the second computing device are linked by the request/reply modules via an email address.

18. A method, comprising:
displaying an invite GUI to receive an email address to link a first computing device and a second computing device for communication;
receiving, at a first computing device with a request content graphical user interface (GUI) button, a user input to request content from a second computing device;
transmitting a request for content from the first computing device to the second computing device;
receiving the request for content at the second computing device;
displaying a list of pending received requests for content on a GUI of the second computing device;
displaying an add content GUI on the second computing device to receive a user selection of content to transmit to the first computing device;
receiving, via the add content GUI, the user selection of content to transmit to the first computing device in response to the request for content;
transmitting the user-selected content to the first computing device;
receiving the user-selected content at the first computing device;
and
displaying the user-selected content on a GUI of the first computing device.

19. The method of claim 18, wherein at least one of the first computing device and the second computing device is a smartphone.

20. The method of claim 18, wherein displaying the user-selected content on the GUI of tire first computing device further Includes displaying the user-selected content in a timeline on the GUI of the first computing device.
